(19) United States
(12) Patent Application Publication
(10) Pub. No.: US 2013/0253885 A1
(43) Pub. Date: Sep. 26, 2013

(54) METHOD AND APPARATUS FOR PROVIDING PERFORMANCE RECOMMENDATIONS DURING DATA MIGRATION

(71) Applicants: MARC BIRNKRANT, POWAY, CA (US); GARY LYONS, SAN DIEGO, CA (US)

(72) Inventors: MARC BIRNKRANT, POWAY, CA (US); GARY LYONS, SAN DIEGO, CA (US)

(73) Assignee: Sony Corporation, Tokyo (JP)

(21) Appl. No.: 13/425,230

(22) Filed: Mar. 20, 2012

(51) Int. Cl. G06F 11/30

(52) U.S. Cl. 702/186

(57) ABSTRACT

Computer-implemented methods for providing performance recommendations during data migration comprising collecting user data and a plurality of running parameters from a user computer, analyzing the plurality of running parameters of the user computer; and suggesting performance recommendations on the basis of the analyzed parameters.

### CROSS REFERENCE TO RELATED APPLICATIONS

Commonly assigned and related U.S. patent application Attorney Docket No. SCA2356, entitled “Method and Apparatus for Providing Data Migration Services”, filed simultaneously herewith, is hereby incorporated in its entirety herein.

### BACKGROUND

1. Field of the Invention

Embodiments of the present invention generally relate to computer backup and restoration techniques, and more specifically to methods and apparatus for providing value added services during data migration.

2. Description of the Related Art

In general, when a personal computer (PC) or notebook computer becomes outdated, its user often wishes to upgrade to a new computer. There are various challenges a user may face for performing back up and restoration operations on the new computer.

Some of the conventional techniques perform data migration by offering technical support for configuring a new computer; however, these processes usually occur when the new computer reaches the user. Further, the conventional techniques which perform data migration are unable to offer value added services to the user. As a result, a user may not have the best user experience due to poorly configured system settings, hardware incompatibility or the like.

Therefore, there exists a need of a method and apparatus for providing value added services, for example suggesting hardware improvement(s), software/license upgrade(s) and/or other performance related fixes during data migration, so as to help ensure the best user experience when the user upgrades to a new computer.

### SUMMARY OF THE INVENTION

Embodiments of the present disclosure generally include computer-implemented methods for providing performance recommendations during data migration comprising collecting user data and a plurality of running parameters from a user computer, analyzing the plurality of running parameters of the user computer; and suggesting performance recommendations on the basis of the analyzed parameters. In some embodiments a new computer is imaged based on the collected user data and suggested performance recommendations that were accepted by the user.

Embodiments of the present disclosure generally include apparatuses for providing value added services during data migration comprising a migration module for analyzing user data and a plurality of running parameters of the user computer, and suggesting performance recommendations on the basis of the analyzed parameters. In some embodiments a new computer is imaged based on the collected user data and suggested performance recommendations that were accepted by the user.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a functional block diagram of a system for providing value added services during data migration in accordance with exemplary embodiments of the present invention; and

FIG. 2 illustrates a flow diagram of a method for providing value added services during data migration in accordance with exemplary embodiments of the present invention.

### DETAILED DESCRIPTION

As explained further below, various embodiments of the invention disclose methods and apparatus for providing performance suggestions during data migration. The embodiments of the invention download a software application (such as an Applet or ActiveX control) to the user computer, as disclosed in related co-pending U.S. patent application Attorney Docket No. SCA2356 and incorporated by reference herein, and then collects one or more of personal settings, hardware/software/performance related parameters, as well as machine settings (collectively referred to hereinafter as “user data” for data that is merely collected by the downloaded software application and “analysis data” for data that is developed from analysis of the user data), and offer suggestions for one or more of replacing the computer, modifying the computer's hardware components, upgrading and/or installing new software and modifying system settings, so as to increase the performance from the computer as a result of more efficient use of its hardware/software/settings and configurations (hereinafter collectively referred to as “performance recommendations”).

Further, the applet and/or ActiveX (or any suitable application) can determine the utilization profile of the user computer and suggests an appropriate replacement notebook and hardware suggestions, such as a larger hard disk drive (HDD) or an increased memory. In addition, the user's data can be analyzed to present a profile indicating, for example, which software is not in use, which is used often and may need an upgrade, and the like. Further, the embodiments can detect any user installed software that may be impeding the computer's performance and share it with the user. In related co-pending U.S. patent application Attorney Docket No. SCA4204, a manufacturing service retrieves this user data from the server and images the new PC with the data. In accordance with embodiments of the present invention, the new PC is also imaged so as to include those suggested recommended parameters that were accepted by the user. The new PC is then shipped to the customer. Once the customer powers on the new PC, the transition from the old computer will be seamless, since all of the user's data and settings are preconfigured on the new PC. The user suffers no pains in manual migration and resumes their usage immediately.

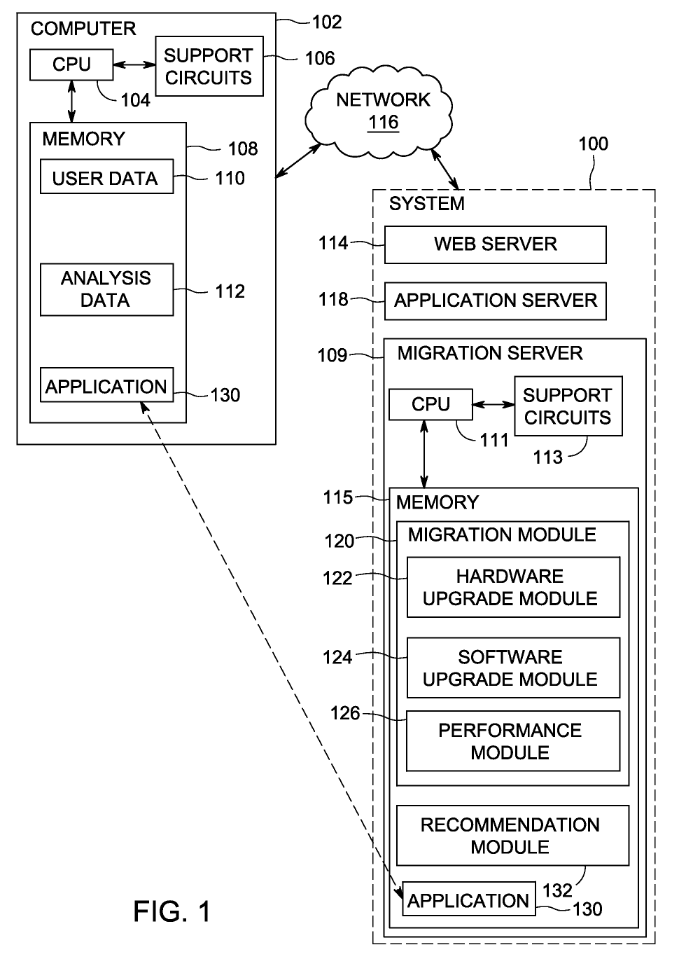

FIG. 1 depicts a functional block diagram of a system 100 for providing performance suggestions during data migration in accordance with exemplary embodiments of the present invention. A client computer 102 interacts with the system 100 through a network 116. The system 100 comprises a web server 114, an application server 118 and a migration server 109 operatively coupled to each other.

The computer 102 comprises a central processing unit (CPU) 104, supports circuit 106, and a memory 108. The computer 102 is a type of computing device (e.g., a laptop, a desktop, a notebook, a gaming device, a handheld device, other electronic device and/or the like) known to one of ordinary skill in the art. The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, displays, and the like. The memory 108 comprises at least one of Read Only Memory (ROM), Random Access Memory (RAM), disk drive storage, optical storage, removable storage and/or the like, excluding transitory signals. The memory 108 comprises user data 110 and analysis data 112.

The system 100 comprises a web server 114, an application server 118 and a migration server 109. The migration server 109 comprises a CPU 111, supports circuit 113, and a memory 115. The migration server 109 is a type of computing device known to one of ordinary skill in the art and one such migration server is described in detail in the fore noted co-pending U.S. patent application Attorney Docket No. SCA2356. The CPU 111 may comprise one or more commercially available microprocessors or microcontrollers that facilitate data processing and storage. The various support circuits 113 facilitate the operation of the CPU 111 and include one or more clock circuits, power supplies, cache, input/output circuits, displays, and the like. The memory 115 comprises at least one of Read Only Memory (ROM), Random Access Memory (RAM), disk drive storage, optical storage, removable storage and/or the like, excluding transitory signals. The memory 108 comprises a migration module 120. The migration module 120 further comprises a hardware upgrade module 122, a software upgrade module 124, a performance module 126 and a recommendation module 132.

The network 116 comprises a communication system that connects computers by wire, cable, fiber optic and/or wireless link facilitated by various types of well-known network elements, such as hubs, switches, routers, access points and the like. The network 116 may employ various well-known protocols to communicate information amongst the network resources. For example, the network 116 may be a part of the Internet or Intranet using various communications infrastructure, such as Ethernet, Wi-Fi, Wi-Max, General Packet Radio Service (GPRS), and the like.

The web server 114 is a type of computing device (e.g., a desktop, and/or the like) known to one of ordinary skill in the art. According to some embodiments, the web server 114 may be a web server or any other server that may utilize the services from an online store, such as Sony Style®, for providing data migration and restoration services to the user.

The application server 118 is a type of computing device (e.g., a desktop, and/or the like) known to one of ordinary skill in the art. The application server 118 hosts the analysis software and uses the web server 114 to distribute the software to client computers such as computer 102.

According to some embodiments, upon a request to the web server 114, the application server 118 transmits a software application 130 (such as an applet or ActiveX® control) to the user computer, i.e. the computer 102 through the web server 114. In some embodiments, the server 114/118 distributes the software to a web browser for the web browser to execute the applet on the computer 102. The applet is a tool that not only accesses settings and files from the existing device (i.e. the computer 102), but also assesses information regarding all of the setup components from the existing device that the user would need to have built into a new device.

According to some embodiments, the software application 130 enables the servers 114/118 to collect personal settings, hardware/software related parameters, as well as machine settings. Further, the software application 130 can perform an analysis to determine the utilization profile of the computer 102 and suggests an appropriate replacement notebook and hardware suggestions, such as larger hard disk drive (HDD) or more memory. In addition, the user's data can be analyzed to present a profile, for example which software is not in use, which is used often and may need an upgrade and the like. Upon performing the above-noted analysis, software application 130 develops the analysis data 112. Further the embodiments can detect any user installed software that may be impeding the performance of computer 102 and the recommendation module 132 correlates all the collected user data 110 and analysis data 112 and shares performance recommendations with the user.

The migration server 109 collects the user data, i.e. the data 110 residing on the computer 102, through the web server 114 and the application server 118. The applet or ActiveX control is hosted by the web server 114 whose backend is controlled by the application server 188. The application server 118 transfers data between the application server 118 and the migration server 109. The user data 110 may include the basic file system of the computer 102 and all data populating the file system to be migrated to the new computer. According to some embodiments, the user data 110 may include MS word files, Adobe PDF files, media (audio/video) files, and/or the like. According to some embodiments, the migration module 120 stores the analysis data 112 of the computer 102 in a hardware upgrade module 122, software upgrade module 124, and a performance module 126. In some embodiments, the analysis data 112 and the user data 110 are encrypted and sent to the application server 118, where the server 118 then builds and configures a new computer in accordance with the received migration data, in a manner similar to that disclosed in commonly assigned and related co-pending U.S. patent application Attorney Docket No. SCA2356.

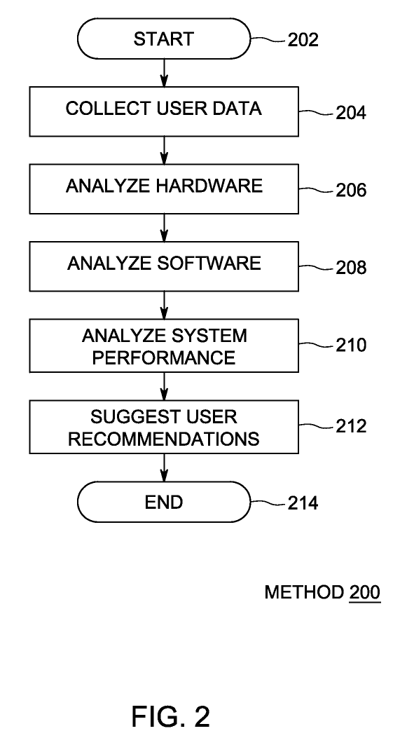

FIG. 2 is a flow diagram of a method 200 for providing value added services during data migration in accordance with exemplary embodiments of the present invention. The method 200 is an exemplary implementation of the migration module 120 stored in memory 115 as executed by the CPU 111. The method 200 begins at step 202 and proceeds to step 204. At step 204, user data 110 is collected by a software application 130 transmitted to the computer 102 by the migration module 120. According to some embodiments, the web server 114 or any other server 118 downloads the software application 130 to the computer 102. In some embodiments, the software application 130 executes on a web browser of the computer 102 to collect the user data 110 and the analysis data 112. According to some embodiments, the user data 110 may include MS word files, Adobe PDF files, media (audio/video) files, and/or the like. The data 110 may further include the basic file system of the computer 102 and all data populating the file system to be migrated to the new computer.

At step 206, the hardware upgrade module 124 analyzes hardware of the computer 102. The analysis may include checking for component incompatibilities, component malfunctions or component driver expiry. In addition, the analysis may check if newer and more efficient components compatible with computer 102 are available for purchase or upgrade. The analysis may also determine if the computer 102 has sufficient memory based on usage patterns. In other embodiments, the analysis may include determining if there is sufficient free disk space on the computer 102's hard disk drive and estimating when the hard disk drive will be full according to current use patterns.

At step 208, the software on computer 102 is analyzed by the software upgrade module 124. According to some embodiments, the method 200 analyzes the software or other running applications and licenses thereof of the computer 102. The software analysis may include indexing the user's software use patterns, types of software installed and upgrades to that software. If, for example, the user has a trial version of a Sony® application installed, the analysis may store this information for future upgrade offers. The usage patterns of the user will be correlated to the hardware component usage and sufficient hard disk memory or RAM may be noted by the method for future upgrade offers. As an example, the analysis may determine that the user is using Paint Shop® or MSPaint® and make a notation to offer the user an upgrade to a Sony® application for image editing.

At step 210, system performance is analyzed by the performance module 126. According to some embodiments, the method 200 analyzes the system performance of the computer 102. According to some embodiments, the web server 114/the application server 118 may run the applets to collect analysis information, i.e. the analysis data 112 of the computer 102. The system performance analysis may comprise reading CPU usage, memory usage, Windows® “system” calls and the like to establish a baseline in determining whether hardware and software components are efficiently configured. The analysis may also inspect the control panel settings of Microsoft® Windows® to determine if ideal settings for the user's usage pattern are configured. The analysis may also determine if enough virtual memory is allocated for memory paging in Windows®. The analysis may also determine if installed software is impeding system performance.

At step 212, performance recommendations are suggested by the recommendation module 132. According to some embodiments, the method 200 suggests hardware upgrade recommendations, software upgrade recommendations and system configuration changes as performance recommendations to the user so that the user may have an ideal and enhanced computer migration experience. Alternatively, the recommendation module 132 suggests the user upgrade their Operating System or a particular piece of software, or purchase a license to alternative software with better capabilities according to the user profile. According to yet another embodiment, the method 200 suggests performance recommendations and processes the purchase order to build a new computer that incorporates all of the settings and choices accepted by the user. Finally, according to some embodiments, the new computer is imaged to receive the data/hardware/software and settings as per the user accepted recommendations and is shipped to the user fully preconfigured according to the users instructions as disclosed in related co-pending U.S. patent application Attorney Docket No. SCA2356. However, as disclosed herein, the user instructions are the result of automated suggested recommendations based on analysis of the user's computer. The method 200 proceeds to step 214, at which the method 200 ends.

The embodiments of the present invention offer various advantages. The embodiments provide an end-to-end value added data migration services that provides a seamless customer migration from one computer to a second computer in a short time and in a user friendly manner. The user may browse a website or electronics storefront to initiate and complete the system analysis, purchase and migration process. Further the migration process can be initiated even from a home without having to understand the details of the system information, such content, settings, user preferences, system analysis parameters, such as hardware, software or other performance parameters, etc. Finally, when the new PC is received, the user awakens the new PC from hibernation with data and settings preconfigured to be equivalent to the data and settings uploaded during migration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A computer-implemented method for providing performance recommendations during data migration, comprising:
collecting user data and a plurality of running parameters from a user computer;
analyzing the plurality of running parameters of the user computer; and
suggesting performance recommendations on the basis of the analyzed parameters.

2. The method of claim 1, further including imaging a new computer based on the collected user data and suggested performance recommendations that were accepted by the user.

3. The method of claim 1, wherein analyzing the plurality of running parameters comprises monitoring hardware of the user computer.

4. The method of claim 1, wherein analyzing the plurality of running parameters further comprises monitoring one or more software applications of the user computer.

5. The method of claim 1, wherein analyzing the plurality of running parameters further comprises monitoring performance of the user computer.

6. The method of claim 4, wherein analyzing the plurality of running parameters comprises running a software application remotely on a browser of the user computer.

7. The method of claim 1, wherein the suggesting performance recommendations comprise one or more of suggesting hardware upgrades, software upgrades, license purchases and system configuration changes.

8. An apparatus for providing value added services during data migration comprising:
a migration module for analyzing user data and a plurality of running parameters of the user computer, and suggesting performance recommendations on the basis of the analyzed parameters.

9. The apparatus of claim 8, further comprising a hardware upgrade module for monitoring hardware of the user computer.

10. The apparatus of claim 8, further comprising a software upgrade module for monitoring one or more software applications of the user computer.

11. The apparatus of claim 8, further comprising a performance module for monitoring performance of the user computer.

12. The apparatus of claim 10, wherein analyzing the plurality of running parameters comprises running a software application remotely on a browser of a user computer.

13. The apparatus of claim 8 further comprising a recommendation module for suggesting system configurations to enhance user experience.

14. The method of claim 8, further comprising a migration module for imaging a new computer based on the collected user data and suggested performance recommendations that were accepted by the user.
